(19) United States
(12) Patent Application Publication
(10) Pub. No.: US 2008/0071725 A1
(43) Pub. Date: Mar. 20, 2008

(54) User-converted media marketplace

(75) Inventors: Oliver Raskin, Portland, OR (US); Chris Kalaboukis, Los Gatos, CA (US); Ron Martinez, San Francisco, CA (US)

Correspondence Address: MORRISON & FOERSTER LLP, 425 MARKET STREET, SAN FRANCISCO, CA, 94105-2482, US

(73) Assignee: Yahoo! Inc., Sunnyvale, CA (US)

(21) Appl. No.: 11/514,413

(22) Filed: Sep. 1, 2006

(51) Int. Cl. G06F 17/30

(52) U.S. Cl. 707/1

(57) ABSTRACT

At a server on a network, the reformatting of media is enabled by indicating that a media object in a first format is available for conversion into a second format, receiving, over the network, a representation of the media object in the second format, associating the media object in the second format with the media object in the first format, and making the representation available to at least one recipient. The representation may be the media object itself or a link to the media object.

### BACKGROUND

1. Field

The present invention generally relates to the field of user-generated content, and, in particular, to enabling creators, modifiers and consumers of such content to interact more freely over a network.

2. Related Art

The past decade has witnessed an explosion in content that is generated not just by mainstream media (MSM) providers, but also by individual users, who, in the past, played primarily a passive consumer role. For example, individual users now can easily create their own websites and blogs. In particular, user-generated websites and blogs have become a popular alternative to MSM as sources of news and entertainment. Some users also find creative expression in modifying or enhancing media that originates with someone else. For example, a user may want to convert an audio track of a song into a music video clip, including video and graphics. Another user may want to convert text to speech to create an audio book.

A media converter may be willing to provide compensation or other consideration to the content originator for use of the content. Conversely, the content originator may want to encourage conversion of the original media, and may be willing to compensate the media converter for such conversion. Moreover, an aggregator of converted content from multiple sources would generally be willing to compensate such sources (which may result in revenue to both the converter and the originator).

It is desired to provide a networked marketplace to make it easy for converter/modifiers to find content to modify, and, on the other hand, for content originators to find converter/modifiers to modify their work. It would also be advantageous to manage the rights in the original and converted media to ensure that the conversion is authorized, and that compensation is provided to the parties.

### BRIEF SUMMARY

At a server on a network, the reformatting of media is enabled by indicating that a media object in a first format is available for conversion into a second format, receiving, over the network, a representation of the media object in the second format, associating the media object in the second format with the media object in the first format, and making the representation available to at least one recipient. The representation may be received over the network from a format converter, and may be the media object itself or a link to the media object.

A provider of the media object in the first format may grant permission to convert the media object in the first format, where permission may be based upon a reputation of the format converter. The provider of the media object in the first format may approve for posting the media object in the second format. Digital rights management may be provided by associating authorized rights with the media object in the second format. The server may also allocate consideration for actions associated with the media object in the second format. The server may suggest, to a converter, a media object for conversion, based upon a reputation or a preference of the converter.

The server may receive, over the network, information regarding a format of an advertisement, determine compatibility between the advertisement format and format capability of a playback device for playing back the media object in the second format, associate the advertisement with the media object in the second format if compatibility is determined, and make the association available to a recipient if compatibility is determined. Compatibility may also be determined based upon the second format. The server may determine placement of the advertisement with respect to presentation of the media object in the second format. based upon, for example, metadata associated with the media object in the second format, or metadata associated with the advertisement.

### BRIEF DESCRIPTION OF THE DRAWINGS

FIG. 1 illustrates a computer network environment according to embodiments of the invention.

FIG. 2 illustrates a flow diagram according to embodiments of the invention.

FIG. 3 illustrates an exemplary computer system that may be used in embodiments of the invention.

### DETAILED DESCRIPTION

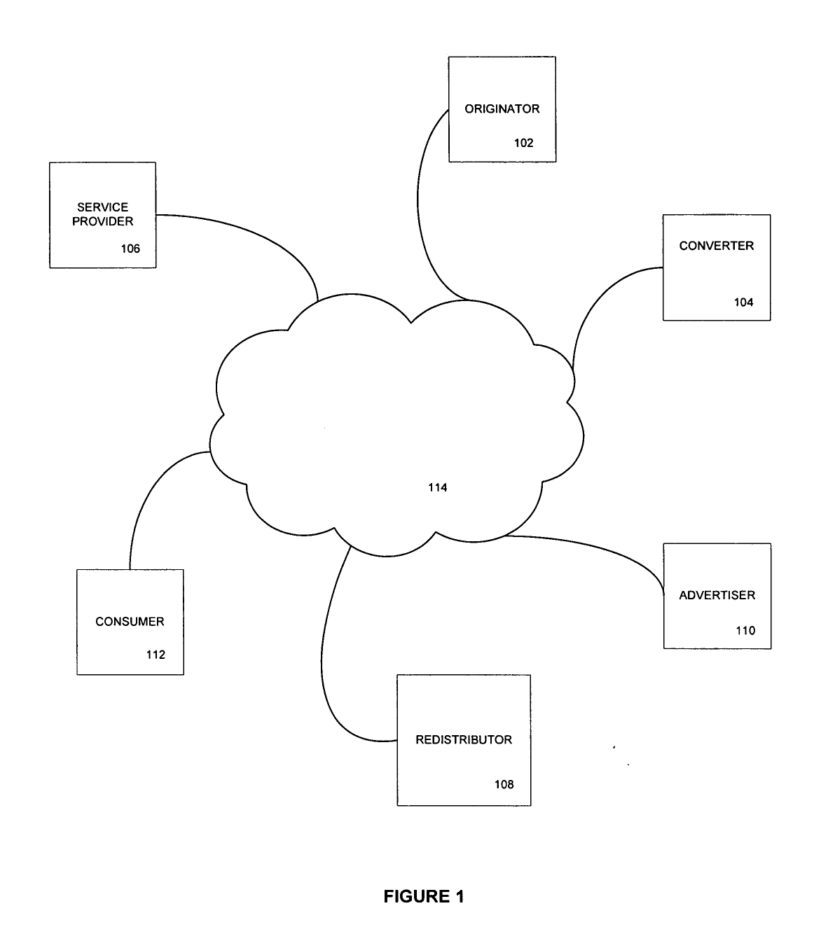

FIG. 1 illustrates a computer network environment according to embodiments of the invention. The network environment includes a content originator 102, a content converter 104, a service provider 106, a content redistributor 108, an advertiser 110, and a content consumer 112, all in communication with each other over a network 114, such as the Internet. Each of the enumerated entities may employ a separate client/server or may share client/servers, as convenience dictates.

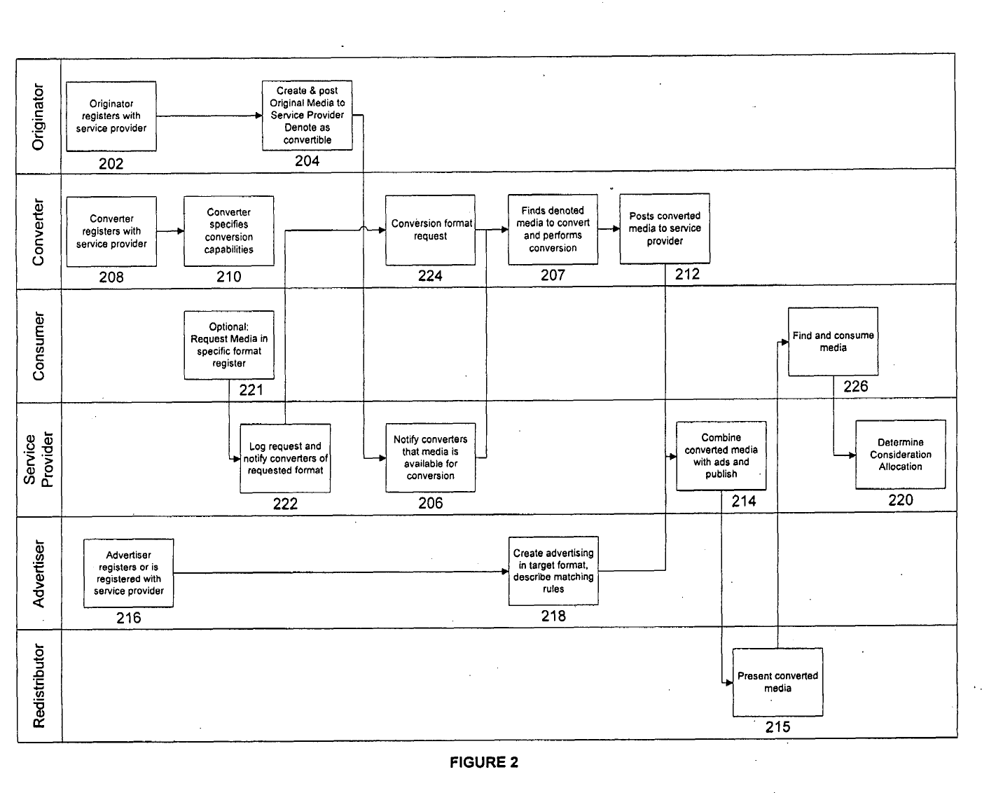

FIG. 2 illustrates a flow diagram of an exemplary process according to embodiments of the invention. To make content available for conversion, the originator 102 may register with the service provider 106, who provides a marketplace for content to be converted (202). During registration, the originator 102 may agree to terms of use concerning issues such as payment and acceptable forms of conversion formats.

The originator 102 creates or otherwise provides content, and makes it available for conversion. The originator 102 may post the content on a web site; in particular, on a site made available by the service provider, e.g., Yahoo! (204). The originator 102 may post on the web site the content itself, or a link to the content. The service provider 106 may push notification of the new content to converters 104 who may have pre-registered an interest in content falling within the relevant category (206). Alternatively, a potential converter of the content may search via the service provider's site for content by category or metadata using well-known techniques (207).

The service provider 106 may publicize the originator's willingness to have its media content converted by making available for display an indicator that the media object is available for conversion (e.g., a “Convert Me” badge may be displayed on the screens of clients viewing the media object) (204). The indicator may be a link to a converter registration process made available by the service provider. The service provider 106 may also indicate that content is available for conversion through other means, including notification to converters through email, SMS or RSS. Those skilled in the art will recognize that the terms “viewing,” “displaying” or the like as used herein refer to acts of perception or presentation, respectively, for different types of media (e.g., audio, video, still images).

The converter 104 may register through the conversion indicator link described above, or by registering directly on the service provider web site (208). During registration the converter may agree to terms regarding payment and other matters. The converter 104 may also indicate to the service provider 106 its conversion capabilities‘both technical and contextual, e.g., text to speech, history of doing sports commentary, music videos, etc. (210).

The conversion may be a straightforward conversion, e.g., text to synthesized speech, and/or may include the addition of other content as well. After the conversion is complete, the converter may upload the converted content and associated metadata to the service provider (212).

The service provider 106 may store the converted content in a storage device or other memory at a network-accessible location, and provide the metadata in a user-searchable form on a consumer-oriented website or other directory. The service provider 106 may associate the converted media object with the unconverted media object, typically through association of their respective metadata.

The service provider 106 may provide digital rights management (DRM) capability for associating authorized rights with the converted media object. The DRM capability may enable the content originator to grant permission to a prospective converter to convert a particular media object based upon, for example, the identity or reputation of the converter (e.g., the converter is known to make high-quality text-to-speech conversions of dramatic material). Further the DRM capability may allow conversion of the media object in the original format into only authorized types of converted formats. For example, the content originator may only authorize conversions of a text into English but not other languages, or authorize conversion of a song lyric into audio with no accompanying images. After conversion, the DRM capability may enable the originator to approve or disapprove the converted content for release to consumers (either directly or through others, such as aggregators or other redistributors).

The service provider 106 may also include a recommendations engine which may suggest new content for a converter 104 to convert based upon one or more factors such as a converter's historical work (e.g., types of conversions previously performed), preferences and user reviews or ratings. For example, the converter may have produced audio conversions of baseball-related blogs originally created in text form. The recommendation engine may identify other baseball-related blogs based upon this conversion history, and recommend to the converter that it may want to convert those blogs. As another example, if the converter has received high ratings by consumers for converting blogs about a specific baseball team, then the recommendation engine may identify text blogs about that team as prospects for audio conversion.

The service provider 106 may associate an advertisement with content reformatted into converted content. By analyzing metadata of the advertisement (e.g., tags), the service provider 106 may determine compatibility between the converted format and the format of the advertisement and/or format capability of the playback device, and associate the advertisement with the reformatted content if compatibility is found. (The originator 102 may specify permitted types of playback capabilities during registration with the service provider 106.) If so, the service provider may then make the association available to a recipient (e.g., a redistributor 108), so that the recipient may display the reformatted content along with the advertisement (214, 215).

For example, the service provider 106 may determine that an advertisement in a still image format, a video format or an audio format may be presented on a web page along with a media object in any of those formats. However, an ad in a video format may not be able to be displayed along with content in an audio format on a portable music player. Note that the ad need not be played at the same time or on the same web page as the converted media. Instead, it may alternatively be sent along a separate channel (e.g., via email or SMS) to the consumer of the converted media.

Like originators 102, converters 104 and redistributors 108, an advertiser 110 may register with the service provider 106 to become part of the converted media marketplace (216). The advertiser 110 may provide the service provider 106 with matching rules to govern the matching of content format with an advertisement (218). The matching rules may be used by the service provider 106 to determine placement of the advertisement with respect to presentation of the converted media object. For example, the matching rules may determine the spatial or temporal position of the ad during presentation of the converted media object based upon metadata associated with the converted media object or based upon metadata associated with the ad itself. In the former case, the content metadata may include preferences of the presenter (e.g., redistributor 108) of the converted content with respect to placement of the ad, such as at a particular time during playback of a song track or video clip, or at a relative position on a screen. For the latter case, the ad metadata may include preferences of the advertiser 110 as to similar factors, as well as preferred media categories to be associated with the ad, such as sports, autos, news.

Consumers 112 may search for content using known search tools, and consume the retrieved content (226). Some consumers 112 may want to search for media in a specific format, such as audio books read by a particular actor. For such works offered by a converter 104 associated with the service provider 106, the service provider 106 may allow the consumer 112 to register and request or search for media according to various criteria, including media format, category, performers, etc. (221). In particular, a consumer may request that content in one format be converted into content in another format (e.g., a blog entry converted into speech). In response, the service provider may select an appropriate converter based upon the converter's reputation or a specific request by the consumer (222), and notify selected converters of the requested format. The service provider may then send the conversion format request to a selected converter (224).

The service provider 106 may allocate consideration among the entities associated with the converted media object (220). The consideration may take the form of a one-time fee, use-based royalty or other monetary compensation. Alternatively, the consideration may include the provision of certain rights, such as the right to place an advertisement or link on the consideration recipient's site.

Consideration may be allocated among various entities depending upon the particular agreement entered into by the parties. For example, the converter 104 may provide consideration to the content originator 102, e.g., for the right to convert and post popular content. Alternatively, the originator 102 may provide consideration to the converter 104, e.g., to encourage the converter to convert and post relatively unpopular content. In both cases, the service provider 106 may receive a portion of the consideration.

As another example, an aggregator or other redistributor 108 of content may provide consideration to the originator 102 and the converter 104, with a portion of the consideration going to the service provider 106 (e.g., an on-line magazine publisher requests audio conversion of text articles into podcasts).

There are a variety of ways in which consideration may be obtained from the ultimate consumption of the converted content by a consumer. The consumer may pay directly through a subscription or via pay per view. Alternatively, an advertiser 110 may pay based upon consumer action associated with an advertisement displayed in conjunction with the ad. Examples of such actions may be pay per click, pay per performance (e.g., sale resulting from click), or pay per 1000 impressions. The consideration may be distributed among the originator and/or the converter and/or the service provider as according to predetermined agreement. Moreover, a third-party conversion requester, such as a redistributor (e.g., on-line magazine publisher) may also receive a share of the consideration.

While the invention has been described in terms of particular embodiments and illustrative figures, those of ordinary skill in the art will recognize that the invention is not limited to the embodiments or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

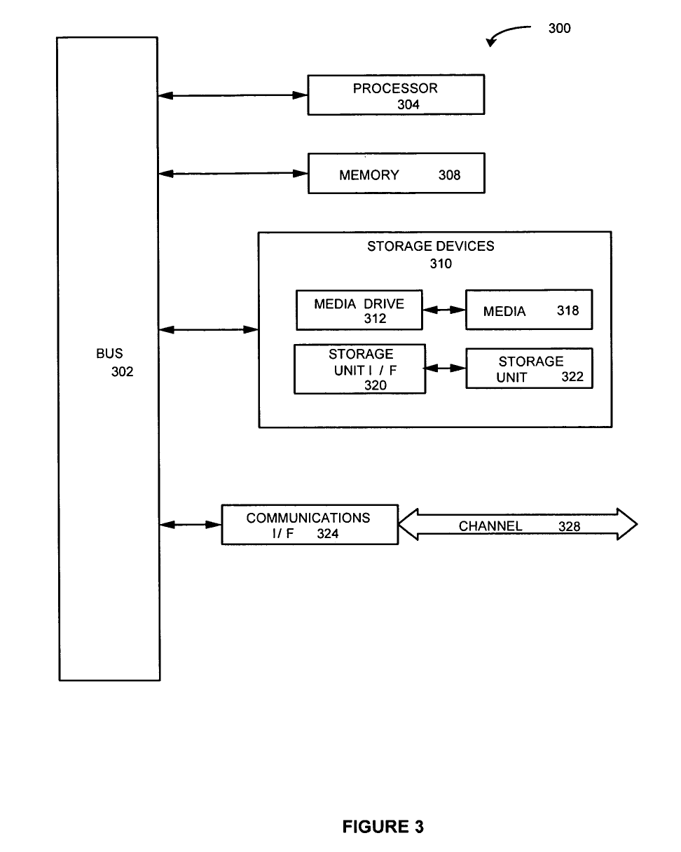

FIG. 3 illustrates a typical computing system 300 that may be employed to implement processing functionality in embodiments of the invention. Computing systems of this type may be used in clients and servers, for example. Those skilled in the relevant art will also recognize how to implement the invention using other computer systems or architectures. Computing system 300 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 300 can include one or more processors, such as a processor 304. Processor 304 can be implemented using a general or special purpose processing engine such as, for example, a microprocessor, microcontroller or other control logic. In this example, processor 304 is connected to a bus 302 or other communication medium.

Computing system 300 can also include a main memory 308, such as random access memory (RAM) or other dynamic memory, for storing information and instructions to be executed by processor 304. Main memory 308 also may be used for storing temporary variables or other intermediate information during execution of instructions to be executed by processor 304. Computing system 300 may likewise include a read only memory (“ROM”) or other static storage device coupled to bus 302 for storing static information and instructions for processor 304.

The computing system 300 may also include information storage system 310, which may include, for example, a media drive 312 and a removable storage interface 320. The media drive 312 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 318, may include, for example, a hard disk, floppy disk, magnetic tape, optical disk, CD or DVD, or other fixed or removable medium that is read by and written to by media drive 314. As these examples illustrate, the storage media 318 may include a computer-readable storage medium having stored therein particular computer software or data.

In alternative embodiments, information storage system 310 may include other similar components for allowing computer programs or other instructions or data to be loaded into computing system 300. Such components may include, for example, a removable storage unit 322 and an interface 320, such as a program cartridge and cartridge interface, a removable memory (for example, a flash memory or other removable memory module) and memory slot, and other removable storage units 322 and interfaces 320 that allow software and data to be transferred from the removable storage unit 318 to computing system 300.

Computing system 300 can also include a communications interface 324. Communications interface 324 can be used to allow software and data to be transferred between computing system 300 and external devices. Examples of communications interface 324 can include a modem, a network interface (such as an Ethernet or other NIC card), a communications port (such as for example, a USB port), a PCMCIA slot and card, etc. Software and data transferred via communications interface 324 are in the form of signals which can be electronic, electromagnetic, optical or other signals capable of being received by communications interface 324. These signals are provided to communications interface 324 via a channel 328. This channel 328 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product,” “computer-readable medium” and the like may be used generally to refer to media such as, for example, memory 308, storage device 318, or storage unit 322. These and other forms of computer-readable media may be involved in storing one or more instructions for use by processor 304, to cause the processor to perform specified operations. Such instructions, generally referred to as “computer program code” (which may be grouped in the form of computer programs or other groupings), when executed, enable the computing system 300 to perform features or functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 300 using, for example, removable storage drive 314, drive 312 or communications interface 324. The control logic (in this example, software instructions or computer program code), when executed by the processor 304, causes the processor 304 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. An apparatus for enabling reformatting of media, wherein the apparatus is located at a server on a network, comprising:
logic for indicating that a media object in a first format is available for conversion into a second format;
logic for receiving, over the network, a representation of the media object in the second format;
logic for associating the media object in the second format with the media object in the first format; and
logic for making the representation available to at least one recipient.

2. The apparatus of claim 1, wherein the logic for receiving is operable to receive the representation over the network from a format converter.

3. The apparatus of claim 1, wherein the representation is the media object itself.

4. The apparatus of claim 1, wherein the representation is a link to the media object.

5. The apparatus of claim 1, further comprising permissions logic for enabling a provider of the media object in the first format to grant permission to convert the media object in the first format.

6. The apparatus of claim 1, further comprising permission logic for enabling a provider of the media object in the first format to approve for posting the media object in the second format.

7. The apparatus of claim 5, wherein the permission logic is further operable to grant permission to a format converter based upon a reputation of the format converter.

8. The apparatus of claim 1, further comprising rights management logic for associating authorized rights with the media object in the second format.

9. The apparatus of claim 1, further comprising logic for allocating consideration for actions associated with the media object in the second format

10. The apparatus of claim 1, further comprising recommendation logic for suggesting to a converter a media object for conversion, based upon a reputation of the converter.

11. The apparatus of claim 1, further comprising recommendation logic for suggesting to a converter a media object for conversion, based upon at least one preference of the converter.

12. The apparatus of claim 1 further comprising:
logic for receiving, over the network, information regarding a format of an advertisement;
matching logic for determining compatibility between the advertisement format and format capability of a playback device for playing back the media object in the second format, and for associating the advertisement with the media object in the second format if compatibility is determined; and
logic for making the association available to a recipient if compatibility is determined.

13. The apparatus of claim 12, wherein the matching logic is further operable to determine compatibility also based upon the second format.

14. The apparatus of claim 12, further comprising placement logic for determining placement of the advertisement with respect to presentation of the media object in the second format.

15. The apparatus of claim 14, wherein the placement logic is operable to determine placement based upon metadata associated with the media object in the second format.

16. The apparatus of claim 14, wherein the placement logic is operable to determine placement based upon metadata associated with the advertisement.

17. A method for enabling reformatting of media, comprising, at a server on a network:
indicating that a media object in a first format is available for conversion into a second format;
receiving, over the network, a representation of the media object in the second format;
associating the media object in the second format with the media object in the first format; and
making the representation available to at least one recipient.

18. The method of claim 17, wherein receiving comprises receiving the representation over the network from a format converter.

19. The method of claim 17, wherein the representation is the media object itself.

20. The method of claim 17, wherein the representation is a link to the media object.

21. The method of claim 17, further comprising enabling a provider of the media object in the first format to grant permission to convert the media object in the first format.

22. The method of claim 17, further comprising enabling a provider of the media object in the first format to approve for posting the media object in the second format.

23. The method of claim 22, wherein the permission logic is further operable to grant permission to a format converter based upon a reputation of the format converter.

24. The method of claim 17, further comprising associating authorized rights with the media object in the second format.

25. The method of claim 17, further allocating consideration for actions associated with the media object in the second format

26. The method of claim 17, further comprising suggesting, to a converter, a media object for conversion, based upon a reputation of the converter.

27. The method of claim 17, further comprising suggesting, to a converter, a media object for conversion, based upon at least one preference of the converter.

28. The method of claim 17 further comprising:
receiving, over the network, information regarding a format of an advertisement;
determining compatibility between the advertisement format and the second format;
associating the advertisement with the media object in the second format if compatibility is determined; and
making the association available to a recipient if compatibility is determined.

29. The method of claim 28, wherein determining compatibility comprises determining compatibility also based upon a format capability of a playback device for playing back the media object in the second format.

30. The method of claim 28, further comprising determining placement of the advertisement with respect to presentation of the media object in the second format.

31. The method of claim 30, wherein determining placement comprises determining placement based upon metadata associated with the media object in the second format.

32. The method of claim 30, wherein determining placement comprises determining placement based upon metadata associated with the advertisement.

33. A computer-readable medium comprising instructions for enabling reformatting of media, the instructions for causing performance of a method comprising:
indicating that a media object in a first format is available for conversion into a second format;
receiving, over the network, a representation of the media object in the second format;
associating the media object in the second format with the media object in the first format; and
making the representation available to at least one recipient.

34. The computer-readable medium of claim 33, wherein receiving comprises receiving the representation over the network from a format converter.

35. The computer-readable medium of claim 33, wherein the representation is the media object itself.

36. The computer-readable medium of claim 33, wherein the representation is a link to the media object.

37. The computer-readable medium of claim 33, the method further comprising: enabling a provider of the media object in the first format to grant permission to convert the media object in the first format.

38. The computer-readable medium of claim 33, the method further comprising: enabling a provider of the media object in the first format to approve for posting the media object in the second format.

39. The computer-readable medium of claim 33, the method further comprising: enabling a provider of the media object in the first format to grant permission to a format converter based upon a reputation of the format converter.

40. The computer-readable medium of claim 33, the method further comprising: associating authorized rights with the media object in the second format.

41. The computer-readable medium of claim 33, the method further comprising: allocating consideration for actions associated with the media object in the second format

42. The computer-readable medium of claim 33, the method further comprising: suggesting to a converter a media object for conversion, based upon a reputation of the converter.

43. The computer-readable medium of claim 33, the method further comprising: suggesting to a converter a media object for conversion, based upon at least one preference of the converter.

44. The computer-readable medium of claim 33, the method further comprising:
receiving, over the network, information regarding a format of an advertisement;
determining compatibility between the advertisement format and format capability of a playback device for playing back the media object in the second format;
associating the advertisement with the media object in the second format if compatibility is determined; and
making the association available to a recipient if compatibility is determined.

45. The computer-readable medium of claim 44, the method further comprising: determining compatibility also based upon the second format.

46. The computer-readable medium of claim 44, the method further comprising: determining placement of the advertisement with respect to presentation of the media object in the second format.

47. The computer-readable medium of claim 46, wherein determining placement comprises determining placement based upon metadata associated with the media object in the second format.

48. The computer-readable medium of claim 46, wherein determining placement comprises determining placement based upon metadata associated with the advertisement.
